(19) United States
(12) Patent Application Publication
(10) Pub. No.: US 2021/0272090 A1
(43) Pub. Date: Sep. 2, 2021

(54) INFORMATION PROCESSING APPARATUS AND INFORMATION PROCESSING METHOD

(71) Applicant: PANASONIC INTELLECTUAL PROPERTY MANAGEMENT CO., LTD., Osaka (JP)

(72) Inventors: Akihito SHIMODE, Kanagawa (JP); Bunzo GOTO, Kanagawa (JP); Masato SHIGEMURA, Kanagawa (JP)

(73) Assignee: PANASONIC INTELLECTUAL PROPERTY MANAGEMENT CO., LTD., Osaka (JP)

(21) Appl. No.: 17/150,509

(22) Filed: Jan. 15, 2021

(30) Foreign Application Priority Data
Feb. 27, 2020 (JP) 2020-032123

(51) Int. Cl. G06Q 20/20; G06F 21/71; G06Q 20/32; G06Q 20/40; H04R 1/02; G06F 3/16

(52) U.S. Cl. CPC G06Q 20/204; G06F 21/71; G06Q 20/3272; G06K 7/10297; H04R 1/028; G06F 3/165; G06Q 20/40

(57) ABSTRACT

An information processing apparatus includes a first area being a security protection area in the information processing apparatus; a second area being outside the security protection area in the information processing apparatus; a first processor arranged in the first area; a second processor arranged in the second area and connected to the first processor; a reader arranged in the first area and connected to the first processor; and a speaker arranged in the second area and connected to the second processor. The first processor acquires a read information from the reader and sends an information on a payment processing related the payment to the second processor. The second processor sends a payment sound information which is a sound related to the payment to the speaker based on the payment processing, and the speaker outputs the payment sound based on the payment sound information.

### CROSS-REFERENCE TO RELATED APPLICATIONS

This application is based on and claims priority under 35 USC 119 from Japanese Patent Application No. 2020-032123 filed on Feb. 27, 2020, the contents of which are incorporated herein by reference.

### TECHNICAL FIELD

The present invention relates to an information processing apparatus and an information processing method.

### BACKGROUND ART

The related art discloses a payment processing apparatus that performs a payment processing and performs near field communication with a storage medium in which an electronic money information is stored. The payment processing apparatus includes an acquisition unit that acquires the electronic money information from the storage medium, and a notification unit that notifies that the payment processing corresponding to the electronic money information is completed (see Patent Literature 1).

### CITATION LIST

### Patent Literature

Patent Literature 1: JP-A-2014-164580

### SUMMARY OF INVENTION

In the payment processing apparatus disclosed in Patent Literature 1, a configuration unit (for example, a payment CPU) for executing a processing related to a payment is not arranged in a security protection area where security can be maintained high. On the other hand, a speaker that outputs a sound and requires low necessity to ensure security is arranged outside the security protection area. In this case, it is difficult for the payment processing apparatus to output a sound related to a payment required in the security protection area from the speaker arranged outside the security protection area while simplifying a configuration of the payment processing apparatus.

The present invention provides an information processing apparatus and an information processing method that can output a sound related to a payment by a simple configuration while maintaining high security related to the payment.

According to an aspect of the present invention, an information processing apparatus includes a first area that is a security protection area in the information processing apparatus; a second area that is outside the security protection area in the information processing apparatus; a first processor that is arranged in the first area; a second processor that is arranged in the second area and is connected to the first processor; a reader that is arranged in the first area and is connected to the first processor; and a speaker that is arranged in the second area and is connected to the second processor. The first processor acquires a read information from the reader and sends an information on a payment processing related a payment to the second processor, the second processor sends a payment sound information to the speaker based on the payment processing, the payment sound information being a sound related to the payment, and the speaker outputs the payment sound based on the payment sound information.

According to an aspect of the present invention, an information processing method of an information processing apparatus is provided. The information processing apparatus includes a first area that is a security protection area in the information processing apparatus, a second area that is outside the security protection area in the information processing apparatus, a first processor that is arranged in the first area, a second processor that is arranged in the second area and is connected to the first processor, a reader that is arranged in the first area, and a speaker that is arranged in the second area. The information processing method includes acquiring a read information from the reader; sending an information on a payment processing related a payment from the first processor to the second processor; sending a payment sound information, which is a sound information related the payment, from the second processor to the speaker based on the payment processing; and outputting a payment sound based on the payment sound information by the speaker.

According to the present invention, a sound related to a payment can be output by a simple configuration while security related to the payment can be maintained high.

### BRIEF DESCRIPTION OF DRAWINGS

FIG. 1A is a top view showing an example of an external appearance of a payment terminal according to a first embodiment.

FIG. 1B is a side view showing an example of the external appearance of the payment terminal.

FIG. 1C is a front view showing an example of the external appearance of the payment terminal.

FIG. 2A is a top view showing an example of a method for using a first card slot.

FIG. 2B is a side view showing an example of the method for using the first card slot.

FIG. 3A is a top view showing an example of a method for using a second card slot.

FIG. 3B is a side view showing an example of the method for using the second card slot.

FIG. 4A is a top view showing an example of a method for making a non-contact payment using the payment terminal.

FIG. 4B is a side view showing an example of the method for making the non-contact payment using the payment terminal.

FIG. 5 is a view showing an example of a touch panel.

FIG. 6 is a rear perspective view showing an example of the external appearance of the payment terminal.

FIG. 7 is a block diagram showing an example of an electrical configuration of the payment terminal.

FIG. 8 is a diagram showing an example of connection between a first CPU and a second CPU, and an example of connection between the second CPU and an external device.

FIG. 9 is a sequence diagram showing an operation example of the payment terminal.

FIG. 10 is a diagram showing a state transition of the payment terminal.

### DESCRIPTION OF EMBODIMENTS

Hereinafter, embodiments will be described in detail with reference to the drawings. However, unnecessary detailed description may be omitted. For example, detailed description of a well-known matter or repeated description of substantially the same configuration may be omitted. This is to avoid unnecessary redundancy in the following description and to facilitate understanding for those skilled in the art. The attached diagrams and the following description are provided to enable those skilled in the art to sufficiently understand the present invention, and are not intended to limit the matters described in the scope of the claims.

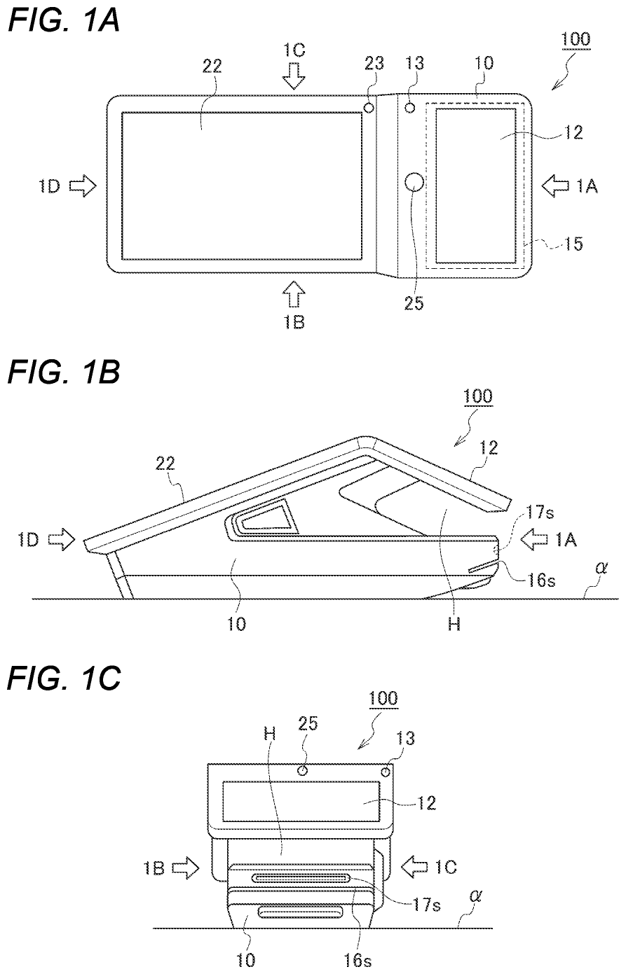

FIG. 1A is a top view showing an example of an external appearance of a payment terminal 100 according to a first embodiment. FIG. 1B is a side view showing an example of the external appearance of the payment terminal 100. FIG. 1C is a front view showing an example of the external appearance of the payment terminal 100.

The payment terminal 100 includes a main body 10. The main body 10 generally has, for example, a box shape. A front side 1A, a side 1B, a side 1C, a rear side 1D of the payment terminal 100 are shown in FIG. 1A, FIG. 1B, and FIG. 1C. For example, a purchaser of a commodity operates the payment terminal 100 from the front side 1A. For example, a store clerk or the like who registers purchase of the commodity operates the payment terminal 100 from the rear side 1D. The purchaser may be a customer of the store.

The payment terminal 100 includes, at the front side 1A, a first touch panel 12, a first light emitting diode (LED) 13, a near field communication (NFC) antenna 15, a first card slot 16s, a second card slot 17s, and a camera 25. The payment terminal 100 includes, at the rear side 1D, a second touch panel 22 and a second LED 23.

The payment terminal 100 is a composite terminal with which a purchaser can select a plurality of payment methods. The payment terminal 100 may be used, for example, in a state of being placed on a placement surface a of a counter of a store.

Examples of the plurality of payment methods include a credit card payment, an electronic money payment, a two-dimensional code (such as a QR code (registered trademark)) payment, and a cash payment. Examples of the credit card payment include a magnetic card payment, a contact IC card payment, and a non-contact IC card payment. Electronic money may include a plurality of types of electronic money. Since the electronic money payment and the non-contact IC card payment are payments using non-contact communication (such as near field communication (NFC)), the electronic money payment and the non-contact IC card payment are also collectively referred to as a non-contact payment.

The plurality of payment methods are respectively performed using a plurality of corresponding payment interfaces. Examples of the plurality of payment interfaces include a credit card, an electronic money card C32, a two-dimensional code, and cash. Examples of the credit card include a magnetic card C1, a contact IC card C2, and a non-contact IC credit card C31.

The magnetic card C1 is used for a payment by being inserted into the first card slot 16s. The contact IC card C2 is used for a payment by being inserted into the second card slot 17s. The non-contact IC credit card C31 and the electronic money card C32 are used for a payment by being brought close to the NFC antenna 15. The non-contact IC credit card C31 and the electronic money card C32 are also collectively referred to as a “non-contact IC card C3”.

In the payment terminal 100, the first card slot 16s, the second card slot 17s, and the first touch panel 12 are arranged in this order from a side close to the placement surface a in a height direction from the placement surface a. The NFC antenna 15 is arranged around the first touch panel 12.

In the payment terminal 100, the first card slot 16s, the second card slot 17s, the first touch panel 12, and the NFC antenna 15 are collectively arranged at the front side 1A facing a purchaser. In this case, the purchaser can easily select any one of the plurality of payment methods corresponding to a plurality of devices arranged in front of the purchaser. Since the plurality of devices corresponding to the plurality of payment methods are gathered at one place, a payment according to each of the payment methods can be performed smoothly.

The second touch panel 22 is provided in the payment terminal 100. The second touch panel 22 is used by, for example, a store clerk, and is provided at the rear side 1D facing a store clerk.

The payment terminal 100 has a mountain shape at an upper portion of the payment terminal 100 as viewed from a side (see FIG. 1B). The mountain shape has a first surface and a second surface. The first surface is a surface on which the first touch panel 12 is provided, and is an operation surface for a purchaser in a payment. The second surface is a surface on which the second touch panel 22 is provided, and is an operation surface for a store clerk in a payment.

With this configuration, the purchaser and the store clerk facing each other can simultaneously operate the payment terminal 100 placed on the placement surface a. For example, when the payment terminal 100 is installed on a counter of a store, a store clerk inside the counter and a purchaser outside the counter can operate the payment terminal 100 in a state in which the store clerk and the purchaser face each other.

In the payment terminal 100, the camera 25 and the first LED 13 are arranged at the front side 1A. At the front side 1A, although the camera 25 and the first LED 13 may be arranged at the rear side 1D relative to the first touch panel 12, that is, at a top side of the mountain shape, arrangement positions of the camera 25 and the first LED 13 are not limited thereto.

In the payment terminal 100, the second LED 23 is arranged at the rear side 1D. At the rear side 1D, although the second LED 23 may be arranged at the front side 1A relative to the second touch panel 22, that is, at a top side of the mountain shape, an arrangement position of the second LED 23 is not limited thereto.

Although the first touch panel 12 and the second touch panel 22 are shown as input devices for a store clerk and a purchaser, the payment terminal 100 may include other input devices (for example, physical keys or buttons).

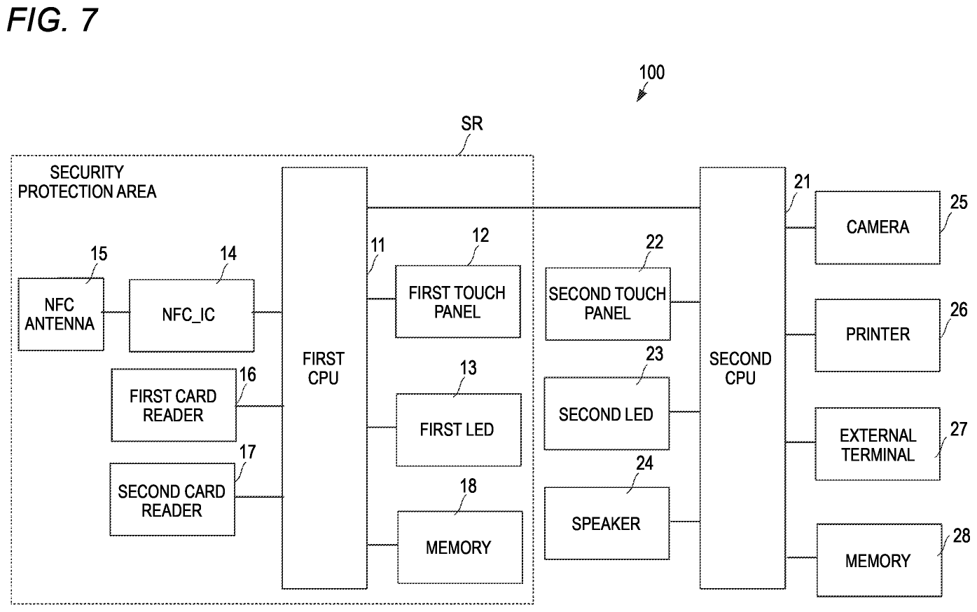

The payment terminal 100 includes a security protection area SR (see FIG. 7) in a part of the payment terminal 100. The security protection area SR is an area where security is increased compared with an area other than the security protection area SR in the payment terminal 100. For example, the security protection area SR has a tamper resistance. Security of the security protection area SR may be logically enhanced by a software processing, or may be physically enhanced by a structure or mechanism of hardware. The security protection area SR mainly stores a member used for a payment processing using a card or the like.

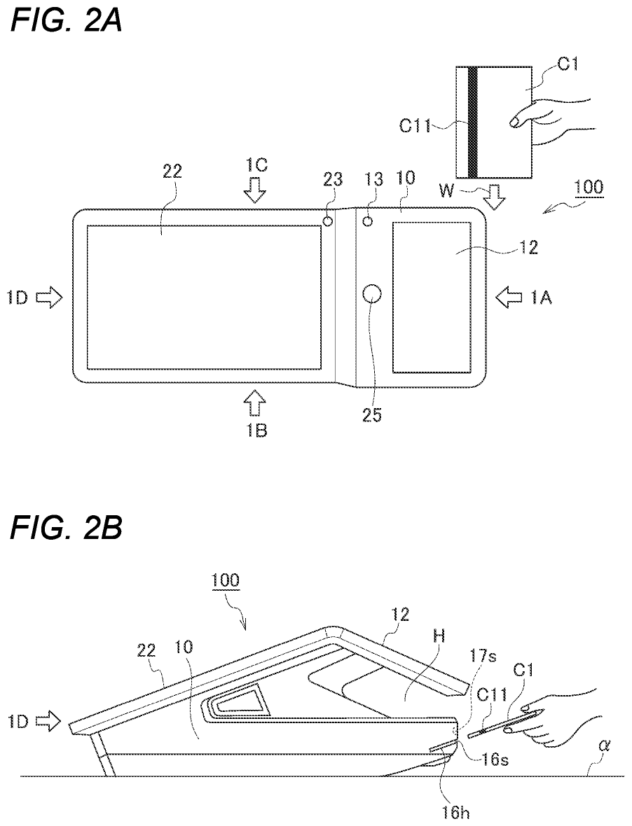

FIG. 2A is a top view showing an example of a method for using the first card slot 16s provided in the payment terminal 100. FIG. 2B is a side view showing an example of the method for using the first card slot 16s provided in the payment terminal 100.

For example, a purchaser is at a position facing the front side 1A (a front surface) of the payment terminal 100, and swipes the magnetic card C1 in the first card slot 16s in a direction w substantially parallel to the placement surface a. The magnetic card C1 includes at least one magnetic stripe C11. On the other hand, a first card reader 16 (see FIG. 7) having the first card slot 16s is provided with a magnetic head 16h. Data is read and written between the payment terminal 100 and the magnetic card C1 by bringing the magnetic stripe C11 into contact with the magnetic head 16h.

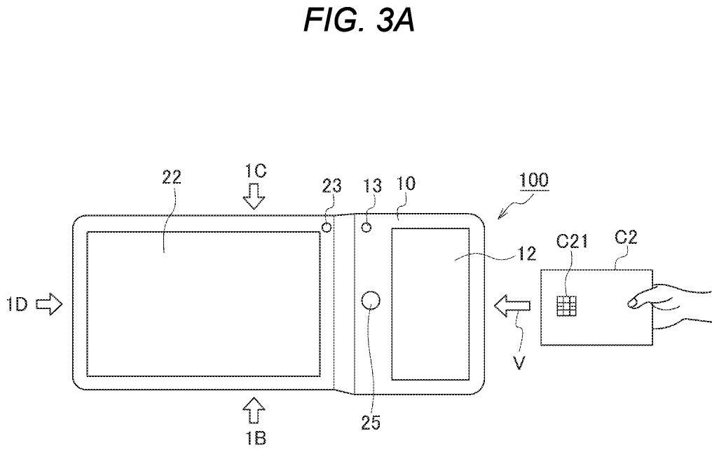

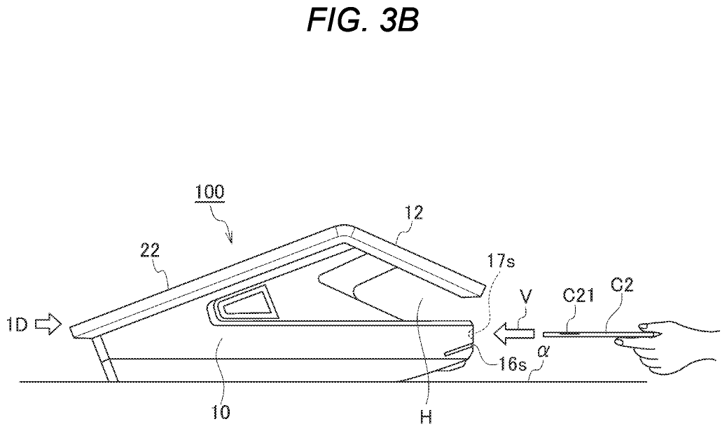

FIG. 3A is a top view showing an example of a method for using the second card slot 17s provided in the payment terminal 100. FIG. 3B is a side view showing an example of the method for using the second card slot 17s provided in the payment terminal 100. A purchaser inserts the contact IC card C2 in a direction v substantially parallel to the placement surface a. The contact IC card C2 includes an IC chip having a terminal C21. On the other hand, the second card slot 17s includes a contact terminal (not shown) therein. Data is read and written between the payment terminal 100 and the contact IC card C2 by bringing the terminal C21 of the IC chip into contact with the contact terminal.

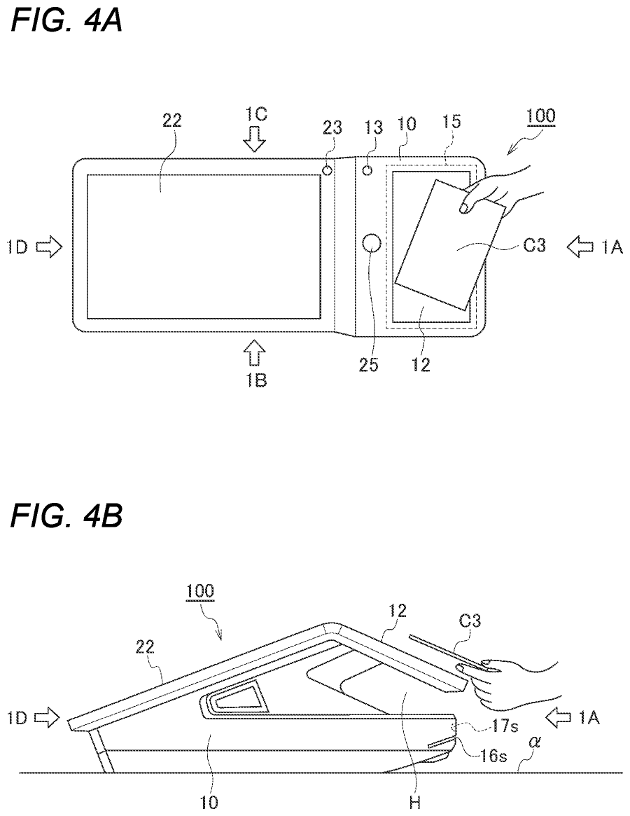

FIG. 4A is a top view showing an example of a method for making a non-contact payment using the payment terminal 100. FIG. 4B is a side view showing an example of the method for making the non-contact payment using the payment terminal 100.

When a non-contact payment is made, non-contact communication is performed between an IC chip of the non-contact IC card C3 and the NFC antenna 15 of the payment terminal 100 by bringing the non-contact IC card C3 into contact with or close to the NFC antenna 15 by a purchaser. Accordingly, data is read and written between the payment terminal 100 and the non-contact IC card C3.

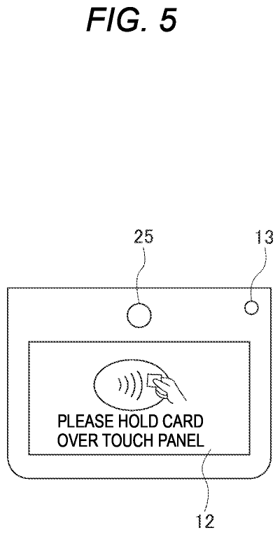

FIG. 5 is a view showing an example of a periphery of the first touch panel 12.

As shown in FIG. 5, the first touch panel 12 may be provided over the entire surface on which the first touch panel 12 is provided, or may be provided on a part of the surface. The first touch panel 12 has a display function of displaying various kinds of data, information, or images. Therefore, the first touch panel 12 can provide visual information to a purchaser. On the first touch panel 12, an input detection area where an input operation is detected and a display area where various kinds of displays are performed may be the same area, or at least a part of the input detection area and the display area may be different areas.

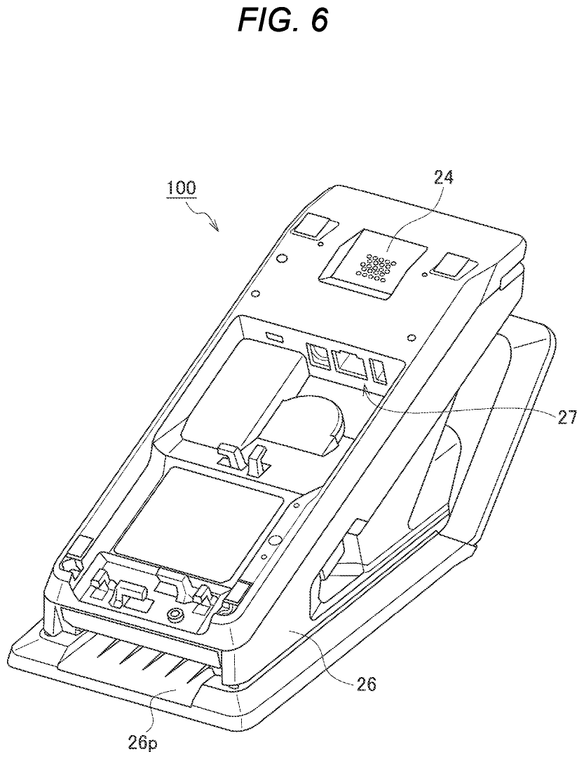

FIG. 6 is a rear perspective view showing an example of the external appearance of the payment terminal 100. At a back surface side (a surface side in contact with the placement surface a), the payment terminal 100 includes a speaker 24, a printer 26, a printer discharge outlet 26p, an external terminal 27, and the like.

FIG. 7 is a block diagram showing an example of an electrical configuration of the payment terminal 100.

The payment terminal 100 includes the security protection area SR. In the security protection area SR, the payment terminal 100 includes a first central processing unit (CPU) 11, the first touch panel 12, the first LED 13, an NFC_IC 14, the NFC antenna 15, the first card reader 16, a second card reader 17, and a memory 18. Outside the security protection area SR, the payment terminal 100 includes a second CPU 21, the second touch panel 22, the second LED 23, the speaker 24, the camera 25, the printer 26, the external terminal 27, and a memory 28.

The first CPU 11 implements various functions by executing a program stored in the memory 18. The first CPU 11 collectively controls devices in the security protection area SR. The first CPU 11 executes a payment processing related to a credit card payment, an electronic money payment, and the like. The first CPU 11 functions as a payment CPU that executes a payment processing related to a payment. The first CPU 11 sends data to and receives data from the second CPU 21, and cooperates with the second CPU 21. The first CPU 11 is an example of a processor, and may be another processor.

The first touch panel 12 has an input detection function that electrically detects an input (an input operation) of bringing a finger of a purchaser (an example of an object) into contact with or close to the first touch panel 12. For example, the first touch panel 12 receives the input operation from the purchaser. For example, the first touch panel 12 receives a PIN input (personal identification number input) operation or an electronic signature operation in a credit card payment.

The first LED 13 performs a display for notifying various kinds of information. The first LED 13 may perform a display in various display modes. Examples of the display modes may include a display color (for example, red, green, and blue), display timing (for example, a display during a payment processing and a display during completion of a payment), and a display pattern (for example, lighting, blinking, and lighting-off). The first LED 13 displays, for example, a payment processing related to a payment.

The NFC_IC 14 performs a processing on the NFC antenna 15. For example, the NFC_IC 14 controls power supply to the NFC antenna 15 and data communication via the NFC antenna 15.

The NFC antenna 15 is formed of, for example, a loop coil. The NFC antenna 15 receives power supply from the NFC_IC 14 and generates radio waves. An area within a predetermined distance from the NFC antenna 15 is an area where non-contact communication with the NFC antenna 15 can be performed (a non-contact communicable area). When the non-contact IC card C3 (an example of a communication media capable of non-contact communication) is arranged in the non-contact communicable area, radio waves from the NFC antenna 15 arrives at the non-contact IC card C3, and the NFC antenna 15 applies start-up power to the non-contact IC card C3. Accordingly, the NFC antenna 15 exchanges data with the non-contact IC card C3.

A central position of a surface defined by the NFC antenna 15 may substantially coincide with a central position of a surface defined by the first touch panel 12. Accordingly, data can be exchanged between the NFC antenna 15 and the non-contact IC card C3 by holding the non-contact IC card C3 over the first touch panel 12, and the operation can be easily understood by a purchaser.

The NFC_IC 14 acquires (reads) an information stored in the non-contact IC credit card C31 via the NFC antenna 15. The NFC_IC 14 sends the acquired information to the first CPU 11 as a non-contact read information. The information stored in the non-contact IC credit card C31 and the non-contact read information include, for example, an identification number of a credit card. The NFC_IC 14 acquires (reads) an information stored in the electronic money card C32 via the NFC antenna 15. The NFC_IC 14 sends the acquired information to the first CPU 11 as an electronic money read information. The information stored in the electronic money card C32 and the electronic money read information include, for example, an identification number of the electronic money card C32.

The first card reader 16 is a magnetic card reader. The first card reader 16 reads an information stored in the magnetic card C1 and sends the read information to the first CPU 11 as a magnetic read information. The information stored in the magnetic card C1 and the magnetic read information include, for example, an identification number of a credit card.

The second card reader 17 is a contact IC card reader. The second card reader 17 reads an information stored in the contact IC card C2 and sends the read information to the first CPU 11 as a contact read information. The information stored in the contact IC card C2 and the contact read information include, for example, an identification number of a credit card.

The memory 18 may include a read only memory (ROM), a random access memory (RAM), or the like. The memory 18 stores various kinds of data, information, and programs. For example, the memory 18 may store an association information in which a type of a payment processing related to a payment and a type of a display of the payment processing related to a payment are associated with each other. The association information may be stored in the memory 18 in a table format. For example, the association information may include an information in which completion of a payment processing and a display content of payment completion are associated with each other. The first CPU 11 may refer to the association information stored in the memory 18 and determine a type (display mode) of a display of a payment processing related to a payment based on a type of the payment processing related to the payment.

The second CPU 21 implements various functions by executing a program stored in the memory 28. The second CPU 21 collectively controls devices outside the security protection area SR. The second CPU 21 executes a processing related to a two-dimensional code payment and a cash payment, a processing other than a payment processing related to a payment, and the like. Therefore, the second CPU 21 functions as a general-purpose CPU that executes a general-purpose processing. The second CPU 21 sends data to and receives data from the first CPU 11 and cooperates with the first CPU 11. The second CPU 21 is an example of a processor, and may be another processor.

The second touch panel 22 receives, for example, an input operation from a store clerk. For example, an amount of money for a commodity purchase is input or the number of purchased commodities is input. The second CPU 21 calculates a payment amount based on the amount of money of a commodity, the number of purchased commodities, or the like. A basic configuration of the second touch panel 22 may be the same as that of the first touch panel 12.

The second LED 23 performs a display for notifying various kinds of information. The second LED 23 may perform a display in various display modes. Examples of the display modes may include a display color (for example, red, green, and blue), display timing, and a display pattern (for example, lighting, blinking, and lighting-off). The second LED 23 displays, for example, a general-purpose processing other than a payment processing.

The speaker 24 outputs various sounds, and outputs, for example, a sound related to a payment processing related to a payment (also referred to as a payment sound). The speaker 24 may output the payment sound in various modes. Output modes of the payment sound may include a sound (frequency) pitch, sound output timing (for example, when a personal identification number is input and when a payment processing is completed), sound output time, a tone color, and the like. The speaker 24 may also output a sound (for example, a sound related to a general-purpose processing) other than the payment sound.

The payment processing related to a payment may include non-contact communication for reading or writing data stored in the non-contact IC card C3. In this case, the payment sound may include a communication completion sound indicating that the non-contact communication has been performed. The payment processing related to a payment may include an input operation of a personal identification number using the first touch panel 12. In this case, the payment sound may include a personal identification number input sound indicating that the input operation of the personal identification number has been performed. The personal identification number input sound may be output each time an input operation is received by the first touch panel 12 (however, in this case, the same sound is output no matter which key is pressed). The payment processing related to a payment may include, for example, a payment processing executed by the first CPU 11 and the second CPU 21 in cooperation. In a case of a credit card payment method, the first CPU 11, the second CPU 21, and a payment server of a payment center may cooperate with each other to execute a payment processing. The payment sound may include a payment completion sound indicating that such a payment processing is completed. The payment processing related to a payment or the payment sound may include other processes or sounds.

The camera 25 images an object and obtains a captured image. For example, the camera 25 images a two-dimensional code displayed on a mobile terminal of a purchaser, and sends the captured image to the second CPU 21. The second CPU 21 analyzes the captured image and recognizes an identification information indicated by the two-dimensional code.

The printer 26 outputs, for example, an information related to a processing (for example, a payment processing) in the payment terminal 100 to a paper medium. For example, after the payment processing, the printer 26 may print out a result of the payment processing on a receipt or the like. A paper on which the printer 26 performed printing is discharged from the printer discharge outlet 26p to an outside of the payment terminal 100.

Various cables (for example, a local area network (LAN) cable and a universal serial bus (USB) cable) can be connected to the external terminal 27. Accordingly, various external devices (for example, a POS and a cash drawer) can be connected to and communicate with the external terminal 27 via the various cables. Therefore, the external terminal 27 functions as a communication device. The communication device may perform wireless communication (for example, wireless LAN communication or Bluetooth (registered trademark) communication) without using the external terminal 27.

The memory 28 may include a ROM, a RAM, or the like. The memory 28 stores various kinds of data, information, and programs. For example, the memory 28 may store an association information in which a type of the payment processing related to a payment and a type of the payment sound are associated with each other. The association information may be stored in the memory 28 in a table format. For example, the association information may include information in which the non-contact communication and the communication completion sound are associated with each other. The association information may include an information in which the input operation of the personal identification number and a personal identification number input sound are associated with each other. The association information may include an information in which completion of the payment processing and the payment completion sound are associated with each other.

The second CPU 21 may refer to the association information stored in the memory, and determine a type of a payment sound (for example, a communication completion sound, a personal identification number input sound, and a payment completion sound) based on the payment processing related to a payment (for example, completion of near filed communication, an input operation of a personal identification number, and completion of a payment processing).

Next, the first CPU 11 and the second CPU 21 will be described in detail.

The first CPU 11 executes a payment processing related to a payment. The payment processing related to a payment may include reading of a credit card, a processing of encrypting an information related to the payment (such as an information and a personal identification number read from a card). The payment processing related to a payment may include reading and writing data among the magnetic card C1, the contact IC card C2, and the non-contact IC card C3. The payment processing related to a payment may include an input operation and a processing of a secure information such as a personal identification number. The payment processing related to a payment may include a processing of reading and writing of the electronic money card C32 and a processing of generating a communication content exchanged with a server of an electronic money provider (also referred to as an electronic money server).

The second CPU 21 may manage power supply for the entire payment terminal 100, execute various displays and notifications for a store clerk or a purchaser via the second LED 23 and the speaker 24, and receive an operation performed by a store clerk via the second touch panel 22. The second CPU 21 may communicate with an external device via the communication device and implement various functions by an application. The various functions may include a POS register function, an inventory and ordering business function, and a daily and monthly business function. The second CPU 21 may execute a two-dimensional code payment. Reading of a barcode may be executed in the two-dimensional code payment. The second CPU 21 communicates with a payment server serving as an external device via the communication device. The second CPU 21 executes a processing such as maintenance and software update of the payment terminal 100.

When data is transmitted from the first CPU 11 to the second CPU 12, the first CPU 11 encrypts the secure information and transmits encrypted data. The secure information is an information having high confidentiality, and is, for example, an information related to a payment.

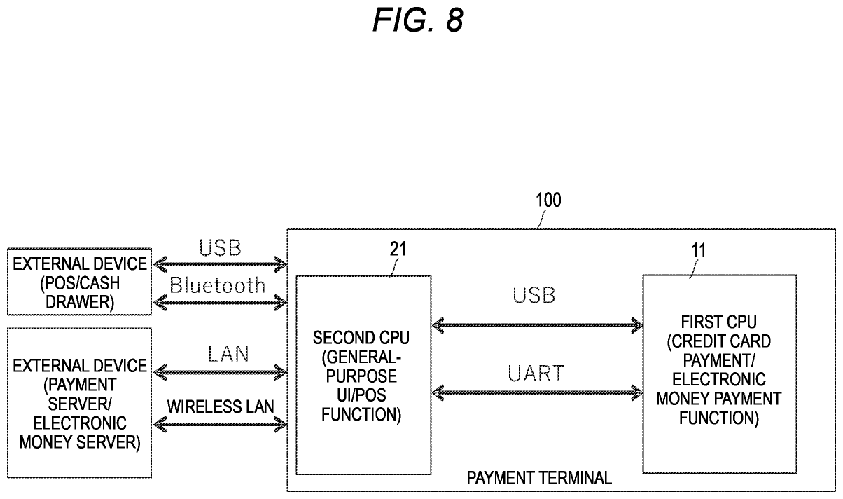

FIG. 8 is a diagram showing an example of connection between the first CPU 11 and the second CPU 21, and an example of connection between the second CPU 21 and an external device.

The first CPU 11 and the second CPU 21 may be connected by a single signal line, or may be connected by multiple signal lines (two in FIG. 8). The multiple signal lines include a USB, a universal asynchronous receiver/transmitter (UART), and the like.

When the first CPU 11 and the second CPU 21 are connected by multiple signal lines, the payment terminal 100 can transmit data between the first CPU 11 and the second CPU 21 using, for example, at least one of two interfaces such as a USB and a UART. Therefore, the payment terminal 100 can transmit data between the security protection area SR and an area outside the security protection area. Further, the payment terminal 100 can monitor whether a CPU is operating normally by regularly performing mutual polling between the first CPU 11 and the second CPU 21 via the signal lines and notifying predetermined data.

By using the UART in a signal line, the payment terminal 100 can ensure reliability of communication and ensure reliability of a payment processing related to a payment that is a processing of handling money. Although the UART has a relatively low communication speed, a data volume is not large in the payment processing related to a payment, and a communication speed required in the payment processing related to a payment can be satisfied. Compatibility of a communication protocol with a payment terminal in the related art can be satisfied by using the UART. When the USB is used, the USB is likely to be cut off inside the terminal while the UART is less likely to be cut off and has high reliability.

When the USB is used in a signal line, the payment terminal 100 can obtain the same effect as that in a case where the UART is used. Here, a payment application for executing a payment processing related to a payment is updated in a timely manner. The payment application is updated under the initiative of the second CPU 21. In this case, the second CPU 21 needs to transmit data of about several tens of MB between the second CPU 21 and the first CPU 11. When the UART is used in the signal line, down time of several minutes to dozens of minutes is required in data transmission of about several tens of MB. On the other hand, the USB can transmit data at a higher speed than the UART. When the USB is used in the signal line, the payment terminal 100 can complete a processing related to an update of the payment application in a short period of time compared with the UART. The payment terminal 100 can transfer an image or the like by performing communication using the USB.

The second CPU 21 and the external device are connected and communicated via the communication device (for example, the external terminal 27). For example, USB communication or Bluetooth (registered trademark) communication is executed between the second CPU 21 and a POS or a cash drawer. For example, wired LAN communication or wireless LAN communication is executed between the second CPU 21 and a payment server or an electronic money server.

Next, an operation example and a screen display example of the payment terminal 100 will be described.

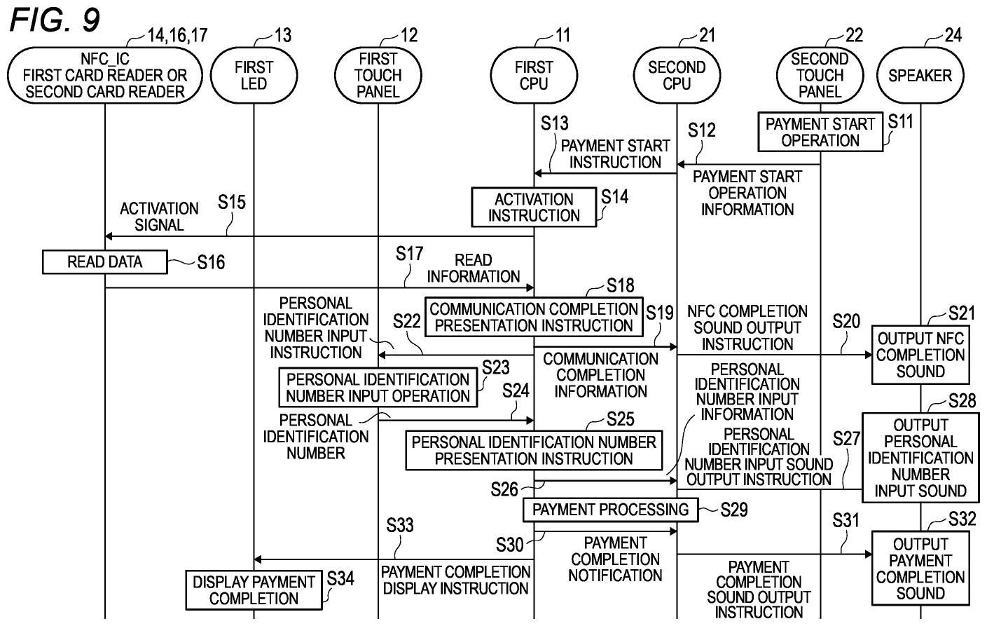

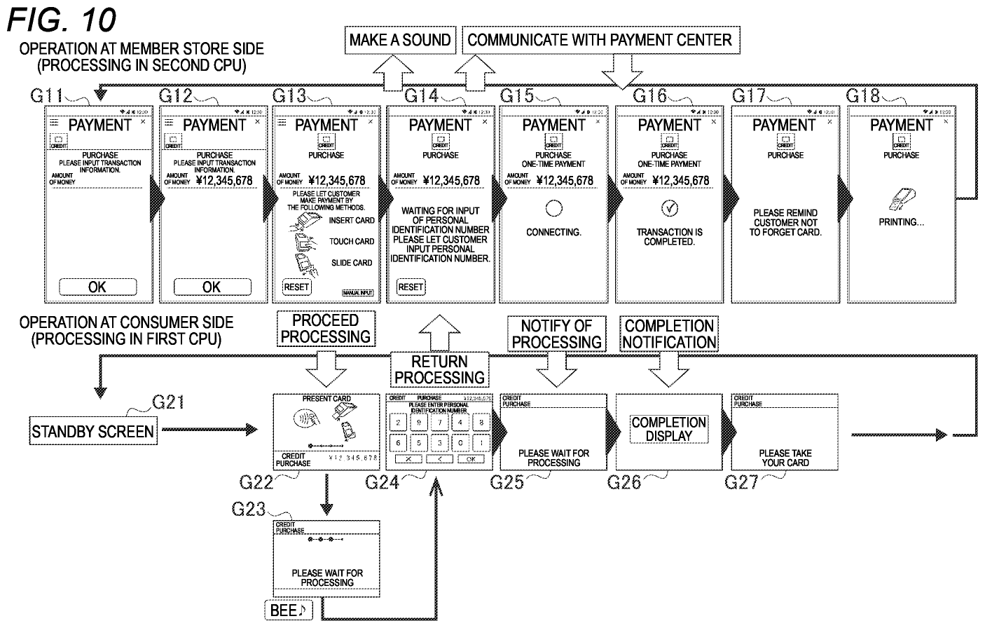

FIG. 9 is a sequence diagram showing an operation example of the payment terminal 100. A processing in FIG. 9 is included in a payment processing related to a payment. FIG. 10 is a diagram showing a transition example of a screen display displayed on the first touch panel 12 and the second touch panel 22. In FIG. 10, the first touch panel 12 is used to receive an input operation from a member store side which is a store clerk side and display various kinds of information. The second touch panel 22 is used to receive an input operation from a consumer side which is a purchaser side and display various kinds of information. On the first touch panel 12, a screen G21 that is a predetermined standby screen is displayed when the processing in FIG. 9 is started.

First, the second touch panel 22 receives a payment start operation for starting a payment processing related to a payment and displays a payment start operation screen for assisting the payment start operation (S11). The payment start operation may include an input operation of a transaction information (for example, a payment amount). Accordingly, the payment start operation screen may include a screen G11 for guiding the input operation of the transaction information. The payment start operation screen may include a screen G12 to which the transaction information is input. The payment start operation may include an input operation for selecting a payment method. Accordingly, the payment start operation screen may include a screen G13 for a store clerk to guide a purchaser about an operation method (such as inserting a card (insertion), touching a card (contact or proximity), and sliding (swiping a card)) of payment interfaces (various cards) corresponding to payment methods.

The second touch panel 22 receives the payment start operation and sends an information on the payment start operation to the second CPU 21 (S12). The second CPU 21 acquires the information on the payment start operation, and sends a payment start instruction to the first CPU 11 in response to the payment start operation (S13).

The first CPU 11 receives the payment start instruction and issues an activation instruction (S14). According to the activation instruction, the first CPU 11 sends an activation signal for activating each device (also referred to as a reader) that reads an information stored in each card to each device (S15). The reader includes, for example, the first card reader 16 that reads the information stored in the magnetic card C1, the second card reader 17 that reads the information stored in the contact IC card C2, and the NFC_IC 14 that reads the information stored in the non-contact IC card C3.

When the reader acquires the activation signal, the reader is activated in accordance with the activation signal. When the reader is activated, the reader can send data to and receive data from each card. The first touch panel 12 displays a screen G22 for guiding a purchaser about an operation method of a payment interface.

The purchaser operates a card on any one of a plurality of readers. Examples of an operation of a card may include insertion of a card, proximity or contact, and swiping. When a card is placed at a predetermined position, a reader reads an information (data) stored in the card (S16), and sends the read information to the first CPU 11 (S17). For example, the first card reader 16 reads an information stored in the magnetic card C1 and sends a magnetic read information to the first CPU 11. For example, the second card reader 17 reads an information stored in the contact IC card C2 and sends a contact read information to the first CPU 11. For example, the NFC_IC 14 reads an information stored in the non-contact IC card C3 and sends a non-contact read information to the first CPU 11. When reading (an example of a data processing) is executed by a reader, the first touch panel 12 displays a screen G23 indicating that the data processing by the reader is being executed.

The first CPU 11 acquires a read information from a reader. When the non-contact read information is acquired from the NFC_IC 14, the first CPU 11 issues a non-contact communication completion presentation instruction (S18). According to the non-contact communication completion presentation instruction, the first CPU 11 sends a communication completion information indicating that the non-contact communication is completed to the second CPU 21 (S19). The second CPU 21 acquires the communication completion information from the first CPU 11, and sends, to the speaker 24, an NFC completion sound output instruction including an NFC completion sound associated with the communication completion information with reference to the memory 28 (S20). The speaker 24 outputs the NFC completion sound (a communication completion sound) according to the NFC completion sound output instruction (S21). A processing related to an output of the NFC completion sound may be executed when the electronic money card C32 is used, or may be executed when another card is used.

The communication completion information and the communication completion sound indicating that the non-contact communication is completed may indicate that reading of data from the non-contact IC card C3 by non-contact communication is completed.

When the first CPU 11 acquires the read information, the first CPU 11 sends an input instruction of a personal identification number to be used in a payment to the first touch panel 12 (S22). According to the input instruction of the personal identification number, the first touch panel 12 displays a screen G24 for guiding an input operation of the personal identification number.

When the first CPU 11 acquires the read information, the first CPU 11 notifies the second CPU 21 that the read information is acquired. In response to the notification, the second CPU 21 sends a display instruction for displaying a screen G14 to the second touch panel 22. The screen G14 is a screen indicating that an input operation of the personal identification number is on standby. The second touch panel 22 displays the screen G14 according to the display instruction.

A user inputs a personal identification number to the first touch panel 12 with reference to the screen G24. The first touch panel 12 receives an input operation of the personal identification number (S23). The first touch panel 12 sends the personal identification number obtained by the input operation to the first CPU 11 (S24).

The first CPU 11 issues a presentation instruction in response to the input operation of the personal identification number (S25). According to the presentation instruction in response to the input operation of the personal identification number, the first CPU 11 sends, to the second CPU 21, a personal identification number input information indicating that the personal identification number is input (S26). The second CPU 21 acquires the personal identification number input information, and sends, to the speaker 24, a personal identification number input sound output instruction including a personal identification number input sound associated with the personal identification number input information with reference to the memory 28 (S27). The speaker 24 outputs the personal identification number input sound according to the personal identification number input sound output instruction (S28).

When a personal identification number has a plurality of digits, the first CPU 11 may send the personal identification number input information to the second CPU 21 each time the personal identification number is input. In this case, the speaker 24 outputs the personal identification number input sound each time a digit of the personal identification number is input. That is, the personal identification number input sound is made for the number of digits of the personal identification number. The first CPU 11 may send the personal identification number input information to the second CPU 21 after an input operation of all digits of the personal identification numbers is completed. In this case, the speaker 24 outputs the personal identification number input sound after all digits of the personal identification numbers are input. That is, the personal identification number input sound is made one time regardless of the number of digits of the personal identification number.

An input operation of the personal identification number may be performed, for example, in a case of the contact IC card payment, and may be omitted in a case of another payment method. In a case of a magnetic card payment, an input operation of the electronic signature may be performed instead of the input operation of the personal identification number. For the input operation of the electronic signature, a processing related to the input of the electronic signature (for example, notification of an electronic signature input information, determination of an electronic signature input sound, and an output of the electronic signature input sound) may be executed in a similar manner to the input operation of the personal identification number. The processing related to the input operation of the electronic signature may be performed after a payment processing is completed.

The first CPU 11 cooperates with the second CPU 12 to execute a payment processing (S29). The payment processing is different depending on a payment method.

For example, in a case of a magnetic card payment, a payment processing using the magnetic read information is executed. The first CPU 11 and the second CPU 21 of the payment terminal 100 and a payment server of a payment center cooperate with each other to execute the payment processing.

For example, the following processes are executed in the payment processing. The first CPU 11 encrypts the magnetic read information and sends the magnetic read information to the second CPU 21. The second CPU 21 transmits a payment request information including the encrypted magnetic read information to the payment server via the communication device. The payment request information may include an identification number of a credit card, a payment amount, and the like. The payment server receives the payment request information from the payment terminal 100, collates the payment request information with an information stored in the payment server, and determines whether to permit a payment by the magnetic card C1 attempting to make a payment. When the payment is permitted, the payment server executes the payment by the magnetic card C1 and completes a transaction of a commodity purchase. The payment server transmits a payment completion notification to the payment terminal 100. When the payment completion notification is received via the communication device, the second CPU 21 sends the payment completion notification to the first CPU 11. When the first CPU 11 receives the payment completion notification from the second CPU 21, the first CPU 11 ends the payment processing. A flow of the payment processing is not limited to this example.

For example, in a case of the contact IC card payment, a payment processing using the contact read information and the PIN is executed. The first CPU 11 and the second CPU 21 of the payment terminal 100 and the payment server of the payment center cooperate with each other to execute the payment processing.

For example, the following processes are executed in the payment processing. The first CPU 11 encrypts the contact read information and the PIN and sends the contact read information and the PIN to the second CPU 21. The second CPU 21 transmits a payment request information including the encrypted contact read information and the PIN to the payment server via the communication device. The payment request information may include an identification number of a credit card, a payment amount, a PIN, and the like. The payment server receives the payment request information from the payment terminal 100, collates the payment request information with an information stored in the payment server, and determines whether to permit a payment by the contact IC card C2 attempting to make a payment. When the payment is permitted, the payment server executes the payment by the contact IC card C2 and completes a transaction of a commodity purchase. The payment server transmits a payment completion notification to the payment terminal 100. When the payment completion notification is received via the communication device, the second CPU 21 sends the payment completion notification to the first CPU 11. When the first CPU 11 receives the payment completion notification from the second CPU 21, the first CPU 11 ends the payment processing. A flow of the payment processing is not limited to this example.

For example, in a case of a non-contact IC credit card payment, the first CPU 11 and the second CPU 21 execute a payment processing using the non-contact read information. The first CPU 11 and the second CPU 21 of the payment terminal 100 and the payment server of the payment center cooperate with each other to execute the payment processing.

For example, the following processes are executed in the payment processing. The first CPU 11 encrypts the non-contact read information and sends the non-contact read information to the second CPU 21. The second CPU 21 transmits a payment request information including the encrypted non-contact read information to the payment server via the communication device. The payment request information may include an identification number of a credit card, a payment amount, and the like. The payment server receives the payment request information from the payment terminal 100, collates the payment request information with an information stored in the payment server, and determines whether to permit a payment by the non-contact IC credit card C31 attempting to make a payment. When the payment is permitted, the payment server executes the payment by the non-contact IC credit card C31 and completes a transaction of a commodity purchase. The payment server transmits a payment completion notification to the payment terminal 100. When the payment completion notification is received via the communication device, the second CPU 21 sends the payment completion notification to the first CPU 11. When the first CPU 11 receives the payment completion notification from the second CPU 21, the first CPU 11 ends the payment processing. A flow of the payment processing is not limited to this example.

For example, in a case of an electronic money payment, the first CPU 11 executes a payment processing using the electronic money read information.

For example, the following processes are executed in the payment processing. The first CPU 11 acquires a payment amount from the second CPU 21. The first CPU 11 reads an owned amount of money stored in the electronic money card C32 via the NFC_IC 14 and the NFC antenna 15, subtracts the payment amount from the owned amount of money, and writes an amount of money of a subtraction result to the electronic money card C32 via the NFC_IC 14 and the NFC antenna 15. Accordingly, the payment processing using the electronic money card C32 is completed. A flow of the payment processing is not limited to this example.

In the payment processing, when the second CPU 21 is communicably connected with the payment server via the communication device, the second CPU 21 sends a display instruction to the second touch panel 22 so as to display a screen G15 indicating that the second CPU 21 and the payment server are being connected. The second touch panel 22 displays the screen G15 according to the display instruction. Then, the second CPU 21 notifies the first CPU 11 that the payment processing is being executed via the communication device.

When the first CPU 21 acquires the notification from the second CPU 21, the first CPU 21 sends a display instruction to the first touch panel 12 so as to display a screen G25. The screen G25 indicates that the payment processing is being executed via the communication device. The first touch panel 12 is notified of such an information. The first touch panel 12 displays the screen G25 according to the display instruction.

When the first CPU 11 recognizes completion of the payment processing, the first CPU 11 sends a payment completion notification (a payment processing completion information) to the second CPU 21 (S30). When the second CPU 21 acquires the payment processing completion information, the second CPU 21 sends, to the speaker 24, a payment completion sound output instruction including a payment completion sound associated with the payment processing completion information with reference to the memory 18 (S31). The speaker 24 outputs the payment completion sound according to the payment completion sound output instruction (S32). In a case of the electronic money payment, a processing related to an output of the payment completion sound may be omitted.

When the first CPU 11 recognizes the completion of the payment processing, the first CPU 11 sends, to the first LED 13, a payment completion display instruction indicating that the payment processing is completed (S33). In this case, the first CPU 11 may determine a display mode of a payment processing completion display associated with the completion of the payment processing with reference to the memory 18. The display mode of the payment processing completion display may be included in the payment completion display instruction. The first LED 13 displays the payment completion according to the payment completion display instruction (S34). For example, the first LED 13 lights up with a predetermined color so as to indicate the completion of the payment processing. In a case of the electronic money payment, a processing relating to the display of the payment completion may be omitted.

When the first CPU 11 recognizes the completion of the payment processing, the first CPU 11 sends a display instruction to the first touch panel 12 so as to display a screen G26 indicating that the payment processing is completed. The first touch panel 12 displays the screen G26 according to the display instruction. Similarly, when the second CPU 21 is notified of the completion of the payment processing, the second CPU 21 sends a display instruction to the second touch panel 22 so as to display a screen G16. The screen G16 is a screen indicating that the payment processing is completed (that is, a transaction is completed). The second touch panel 22 displays the screen G16 according to the display instruction.

After the screen G26 is displayed, the first CPU 11 sends a display instruction to the first touch panel 12 so as to display a screen G27 for guiding a user to take a card. The first touch panel 12 displays the screen G27 according to the display instruction. A transition to the screen 21 may be performed after a screen G28 is displayed, and the payment terminal 100 may repeat the payment processing related to a payment.

After the screen G16 is displayed, the second CPU 21 sends a display instruction to the second touch panel 22 so as to display a screen G17. The screen G17 is a screen for guiding a store clerk to remind a purchaser not to forget to take a card. The second touch panel 22 displays the screen G17 according to the display instruction.

The second CPU 21 sends a print instruction to the printer 26 so as to print a result of the payment processing on a receipt or the like. The printer 26 prints the result of the payment processing according to the print instruction. In this case, the second CPU 21 sends a display instruction to the second touch panel 22 so as to display a screen G18 indicating that the result of the payment processing is being printed. The second touch panel 22 displays the screen G18 according to the display instruction. A transition to the screen G11 may be performed after the screen G18 is displayed, and the payment terminal 100 may repeat the payment processing related to a payment.

Next, the payment terminal 100 according to the present embodiment and a payment terminal according to a comparative example will be described.

In a first comparative example, a payment terminal outputs a payment sound from a first speaker connected to the first CPU, and outputs another sound (for example, a sound related to a general-purpose processing) from a second speaker connected to the second CPU. Compared with the first comparative example, since the speaker 24 is not connected to the first CPU 11 and is connected to the second CPU 21 in the payment terminal 100, it is easy to cooperate with a general-purpose processing regarding an output of a payment sound. Since only one speaker 24 is required, a configuration of the payment terminal 100 can be simplified.

In a second comparative example, a payment terminal outputs a payment sound and another sound (for example, a sound related to a general-purpose processing) from a second speaker connected to a general purpose CPU, but the first CPU and the second CPU does not cooperate with each other. In this case, the payment terminal according to the second comparative example requires a mixer for synthesizing the payment sound and the other sound, and the mixer needs to add signals of sounds and switch outputs of the sounds. In contrast, since the first CPU 11 and the second CPU 21 cooperate with each other in the payment terminal 100, the mixer is not required and a configuration of the payment terminal 100 can be simplified. Since the payment terminal 100 does not need to switch outputs of the sounds by the mixer, generation of a sound (a sound such as “buzz”) generated during switching the outputs of the sounds can be prevented.

As described above, the payment terminal 100 (an example of an information processing apparatus) according to the present embodiment includes a first area that is the security protection area SR and a second area outside the security protection area SR. The payment terminal 100 includes the first CPU 11 (an example of a first processor) arranged in the first area, the second CPU 21 (an example of a second processor) connected to the first CPU 11, and the speaker 24 arranged in the second area and connected to the second CPU 21. The first CPU 11 sends an information on a payment processing related to the payment to the second CPU 21. The second CPU 21 sends a payment sound information that is a sound related to a payment to the speaker 24 based on the payment processing related to a payment. The speaker 24 outputs a payment sound based on the payment sound information.

As a result, even when a processor is arranged inside the security protection area SR and a processor is arranged outside the security protection area SR, the payment terminal 100 can deliver data having high confidentiality and general-purpose data having low confidentiality between the inside and the outside of the security protection area SR. Therefore, even when the general-purpose speaker 24 is arranged outside the security protection area SR, the payment terminal 100 can output a payment sound based on a payment having high confidentiality from the speaker 24. Therefore, the payment terminal 100 can output a sound related to a payment by a simple configuration while maintaining high security related to the payment.

The second CPU 21 may determine a type of the payment sound based on a type of a payment processing related to a payment. The speaker 24 may output a payment sound according to the determined type of the payment sound.

Accordingly, in the payment terminal 100, the first CPU 11 may send the information on a payment processing related to a payment, and the second CPU 21 can determine what kind of sound is to be output. For example, when the first CPU 11 has a lower processing capacity than the second CPU 2, it is possible to output a payment sound with high processing efficiency. Different payment sounds are output corresponding to payment processing related to payments, so that a store clerk or a user can confirm whether an intended processing is performed according to an output sound.

The first touch panel 12 (an example of an operation device) arranged in the first area and used in a payment may be provided. The payment sound may include a personal identification number input sound (an example of an authentication information input sound) indicating that a personal identification number (an example of an authentication information) for a payment is input. The first CPU 11 may acquire the personal identification number input information via the first touch panel 12, and send the personal identification number input information to the second CPU 21. The second CPU 22 may send the personal identification number input sound information to the speaker 24 based on the personal identification number input information. The speaker 24 may output the personal identification number input sound.

Accordingly, the payment terminal 100 can output an authentication information input sound for notifying an input operation of the personal identification number whose security is ensured.

The payment terminal 100 may include the NFC_IC 14 (an example of a non-contact communication device) arranged in the first area and used for a payment. The payment sound may include a communication completion sound indicating that communication (contact communication) is performed by the NFC_IC 14. The first CPU 11 may acquire a communication completion information indicating that the communication has been performed by the NFC_IC 14, and send the communication completion information to the second processor. The second CPU 21 may send an information on the communication completion sound to the speaker 24 based on the communication completion information, and the speaker 24 may output the communication completion sound.

Accordingly, the payment terminal 100 can output the communication completion sound for notifying completion of the non-contact communication in which security is ensured.

The payment sound may include a payment completion sound indicating that a payment processing related to a payment is completed. When a payment processing is completed, the first CPU 11 may send a payment completion information indicating that the payment processing is completed to the second CPU 21. The second CPU 21 may send an information on the payment completion sound to the speaker 24 based on the payment completion information. The speaker 24 may output the payment completion sound.

Accordingly, the payment terminal 100 can notify the completion of the payment processing in which security is ensured by the payment completion sound. The completion of the payment processing may be automatically recognized by the first CPU 11, or may be recognized by the first CPU 11 based on detection of an input operation of payment completion by the first touch panel 12.

The first CPU 11 and the second CPU 21 may be connected by multiple signal lines.

Accordingly, the payment terminal 100 can transmit and receive data between the inside and the outside of the security protection area SR as long as data can be transmitted via at least one signal line. Therefore, even when a failure occurs in some signal lines, data can be stably transmitted between the inside and the outside of the security protection area SR. The payment terminal 100 can transmit data via a signal line (for example, a UART) for transmitting data having high reliability and a signal line (for example, a USB) for transmitting data having a large transmission capacity. Therefore, the payment terminal 100 can, for example, selectively use the signal lines according to an application and can achieve suitable data transmission.

Although the embodiments are described above with reference to the drawings, it is needless to say that the present invention is not limited thereto. It will be apparent to those skilled in the art that various changes and modifications may be conceived within the scope of the claims. It is also understood that the various changes and modifications belong to the technical scope of the present invention. Constituent elements in the embodiments described above may be combined freely within a range not departing from the spirit of the present invention.

In the embodiment described above, although the NFC completion sound, the personal identification number input sound, and the payment completion sound are described as payment sounds in the payment terminal 100, another sound related to a payment may be output.

Although data reading among cards performed by the NFC_IC 14, the first card reader 16, and the second card reader 17 is mainly described in the embodiment described above, data writing may be performed. That is, the NFC_IC 14, the first card reader 16, and the second card reader 17 can at least read data, and may write data.

Although the payment terminal 100 having an external appearance configuration shown in FIGS. 1 to 6 is described in the embodiment described above, the external appearance configuration of the payment terminal 100 is not limited thereto.

In the embodiment described above, a program for implementing a function of the information processing method according to the embodiment described above may be applied to an information processing apparatus which is a computer via a network or various storage media, and a program read and executed by a processor of the information processing apparatus and a recording medium storing the program may also be used as an application range.

In the embodiment described above, the processor may be physically configured in any way. When a programmable processor is used, since the processing content can be changed by changing the program, a degree of freedom in design of the processor can be increased. The processor may be configured with one semiconductor chip, or may be physically configured with a plurality of semiconductor chips. When the processor is configured with a plurality of semiconductor chips, controls of the embodiment described above may be respectively implemented by different semiconductor chips. In this case, it can be considered that one processor is configured with the plurality of semiconductor chips. The processor may be configured with a semiconductor chip and a member having a different function (such as a capacitor). One semiconductor chip may be configured to implement a function of the processor and a function other than the function. One processor may be configured with a plurality of processors.

### INDUSTRIAL APPLICABILITY

The present invention is useful for an information processing apparatus and an information processing method that can output a sound related to a payment by a simple configuration while maintaining high security related to the payment.

What is claimed is:

1. An information processing apparatus comprising:
a first area that is a security protection area in the information processing apparatus;
a second area that is outside the security protection area in the information processing apparatus;
a first processor that is arranged in the first area;
a second processor that is arranged in the second area and is connected to the first processor;
a reader that is arranged in the first area and is connected to the first processor; and
a speaker that is arranged in the second area and is connected to the second processor,
wherein the first processor acquires a read information from the reader and sends an information on a payment processing related a payment to the second processor,
the second processor sends a payment sound information to the speaker based on the payment processing, the payment sound information being a sound related to the payment, and
the speaker outputs the payment sound based on the payment sound information.

2. The information processing apparatus according to claim 1, wherein:
the second processor determines a type of the payment sound based on a type of the payment processing, and
the speaker outputs the payment sound according to the determined type of the payment sound.

3. The information processing apparatus according to claim 1, further comprising:
an operation device that is arranged in the first area and is used for the payment,
wherein the payment sound includes an authentication information input sound indicating that an authentication information for the payment has been input,
the first processor acquires an input information of the authentication information via the operation device and sends the input information to the second processor,
the second processor sends an information of the authentication information input sound to the speaker based on the input information, and
the speaker outputs the authentication information input sound.

4. The information processing apparatus according to claim 1, further comprising:
a non-contact communication device that is arranged in the first area and is used for the payment,
wherein the payment sound includes a communication completion sound indicating that a communication has been performed by the non-contact communication device,
the first processor acquires a communication completion information indicating that a communication has been performed by the non-contact communication device, and sends the communication completion information to the second processor,
the second processor sends an information of the communication completion sound to the speaker based on the communication completion information, and
the speaker outputs the communication completion sound.

5. The information processing apparatus according to claim 1, wherein:
the payment sound includes a payment completion sound indicating that the payment processing has been completed,
when the payment processing has been completed, the first processor sends a payment completion information indicating that the payment processing has been completed to the second processor,
the second processor sends an information of the payment completion sound to the speaker based on the payment completion information, and
the speaker outputs the payment completion sound.

6. The information processing apparatus according to claim 1, wherein:
the first processor and the second processor are connected by multiple signal lines.

7. An information processing method of an information processing apparatus, the information processing apparatus including:
a first area that is a security protection area in the information processing apparatus,
a second area that is outside the security protection area in the information processing apparatus,
a first processor that is arranged in the first area,
a second processor that is arranged in the second area and is connected to the first processor,
a reader that is arranged in the first area, and
a speaker that is arranged in the second area,
the information processing method comprising the steps of:
acquiring a read information from the reader;
sending an information on a payment processing related a payment from the first processor to the second processor;
sending a payment sound information, which is a sound information related the payment, from the second processor to the speaker based on the payment processing; and
outputting a payment sound based on the payment sound information by the speaker.
